(19) United States
(12) Patent Application Publication
(10) Pub. No.: US 2019/0078974 A1
(43) Pub. Date: Mar. 14, 2019

(54) PROCESS AND DEVICE FOR THE SUPERVISION OF THE KINEMATICS OF AN EPICYCLIC PLANETARY GEARBOX

(71) Applicant: Rolls-Royce Deutschland Ltd & Co KG, Blankenfelde-Mahlow, DE (US)

(72) Inventors: Sebastian NOWOISKY, Michendorf (DE); Mateusz GRZESZKOWSKI, Berlin (DE); Christoph ENDE, Berlin (DE)

(21) Appl. No.: 16/110,358

(22) Filed: Aug. 23, 2018

(30) Foreign Application Priority Data
Sep. 13, 2017 (DE) 10 2017 121 239.6

(51) Int. Cl. G01M 13/02; F16H 57/01

(52) U.S. Cl. CPC G01M 13/021; F16H 2057/012; G01M 13/028; F16H 57/01

(57) ABSTRACT

A method for monitoring the kinematics of an epicyclic planetary gearbox to be tested, wherein
a) in a training phase a model of the kinematics is determined based on data measured at an epicyclic planetary gearbox by means of a vibration sensor device; wherein subsequently
b) the model is used in a test phase for pattern recognition in oscillation data of an epicyclic planetary gearbox to be tested, wherein angular positions of at least one planetary wheel in the epicyclic planetary gearbox to be tested are determined by means of the pattern recognition.

The invention also relates to a device for monitoring the kinematics of an epicyclic planetary gearbox.

This application claims priority to German Patent Application DE102017121239.6 filed Sep. 13, 2017, the entirety of which is incorporated by reference herein.

The invention relates to a method for monitoring the kinematics of an epicyclic planetary gearbox with the features of claim 1 and a device for monitoring an epicyclic planetary gearbox with the features of claim 9.

Epicyclic planetary gearboxes are widely used today. Thus, in turbofan aircraft engines, the fan is decoupled from the turbine shaft by using a planetary gearbox. In this manner, an increase in efficiency and a reduction in sound emission can be achieved, since the fan reaches a higher level of efficiency at low rotational speeds while the medium-pressure turbine does so only at very high rotational speeds. However, the use of a gearbox results in an increase in the share of potential wear parts. Monitoring the kinematics of planetary gearboxes is known from DE 10 2015 209 866 A1.

In addition to a time-based maintenance, online monitoring of the kinematics of the planetary gearbox for a diagnosis and prognosis of gearbox damage is also useful.

The objective is achieved by a method with the features of claim 1.

Here, a method for pattern recognition is used. At first, in a training phase, a model (i.e. a calculation model) of kinematics is determined based on data that are measured at an epicyclic planetary gearbox by means of a vibration sensor device.

After that, the model thus obtained is used in a test phase for pattern recognition in oscillation data of an epicyclic planetary gearbox to be tested, wherein angular positions of at least one planetary wheel are determined through the pattern recognition in the epicyclic planetary gearbox to be tested.

Therefore, here the focus is not on the detection of a general gear state but rather on the determination of the angular positions of the planetary wheels in the epicyclic planetary gearbox to be tested.

Here, in one embodiment of the method, the pattern recognition in the test phase can determine the estimate of an initial angular position of the planetary wheels. Together with the model, this estimate can then be used to determine the angular positions in the epicyclic planetary gearbox to be tested. In particular, in one embodiment, the model can comprise a Hidden Markov model and/or an artificial neural network.

The estimate of the initial angular position of the planetary wheels is of interest, as the initial angular position is not accessible through measurements from the outside at the planetary gearbox.

For generating the model in the training phase it is necessary to take into account a sufficiently large number of oscillation data. In one embodiment, the training phase extends at least over the time that is necessary for a tooth meshing periodicity (n_{c,spr}), in particular over the time for an integral multiple of the tooth meshing periodicity (n_{c,spr}).

For processing the oscillation data, in one embodiment, a preprocessing step and/or a feature detection step is carried out, in which a filtering of the oscillation data, a noise reduction of the oscillation data and/or a rotation-angle synchronous post-scanning, as it is used in a TSA algorithm, occurs.

Also, in one embodiment, a classification step with a classifier is carried out in the training phase, in particular chronologically following the preprocessing step, wherein the result of the classification comprises an output probability matrix. Here, one possibility is that the classifier has a k-nearest-neighbor classifier, a support vector machine and/or an artificial neural network, in particular a recurrent artificial neural network. These methods are classification means that are used in the field of machine learning.

Here, the k-nearest-neighbor classifier belongs to the non-parametric classifiers, which have to be acquired by training in a monitored learning process. This means that in the learning process the class assignment of individual feature vectors to the individual classes of states is known. Then, for every new unknown feature vector in the feature space a direct counting k of adjacent class representatives from the training phase is carried out in the classification step in the test phase. The trained k-nearest-neighbor classifier then matches the unknown feature vector to the class with the most representatives of a class.

In one embodiment, a Viterbi algorithm is used in the test phase for determining a most likely sequence of angular states (or a sequence of discrete kinematic rotational angular states), in particular for determining a toothing state that most likely corresponds to the observed oscillation signal patterns in the acquired oscillation data.

The objective is also achieved by a device for monitoring the kinematics of an epicyclic planetary gearbox to be tested having the features of claim 9.

The invention is explained in connection with the exemplary embodiments that are shown in the Figures. Herein

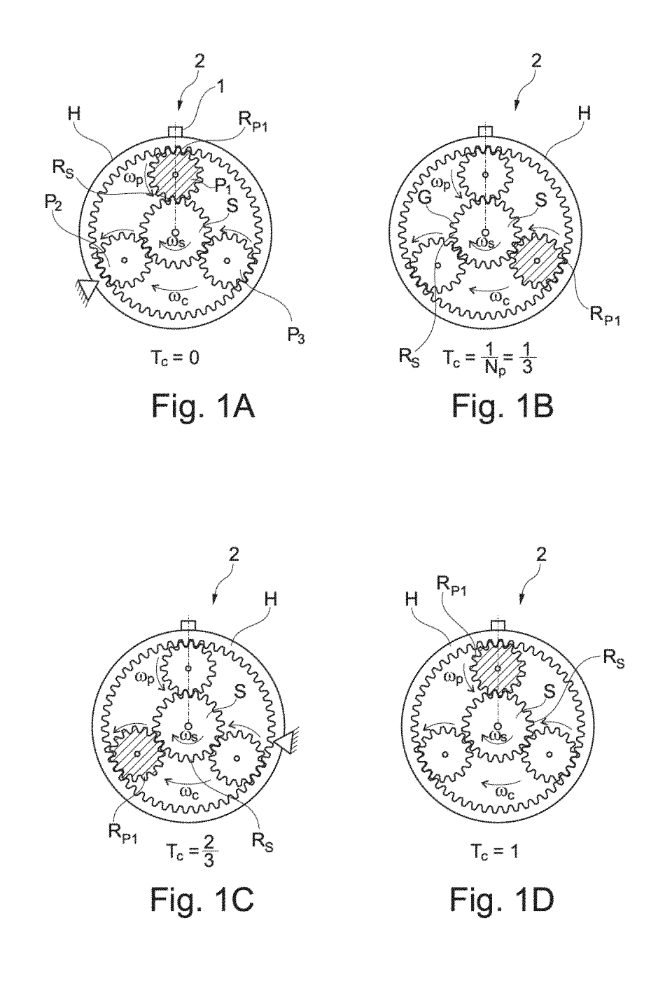

FIGS. 1A to 1D show schematic renderings of different positions of planetary wheels in an epicyclic planetary gearbox;

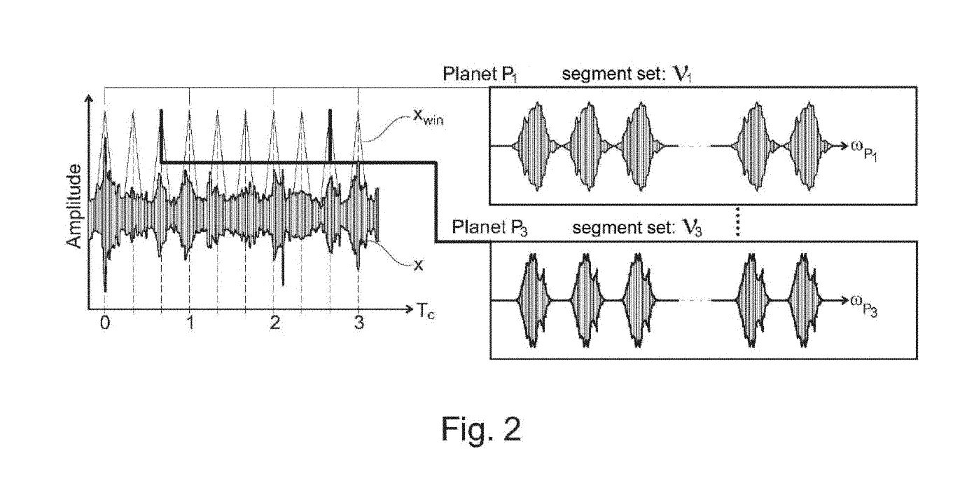

FIG. 2 shows a rendering of a rotation-angle synchronous windowing of the vibration signals;

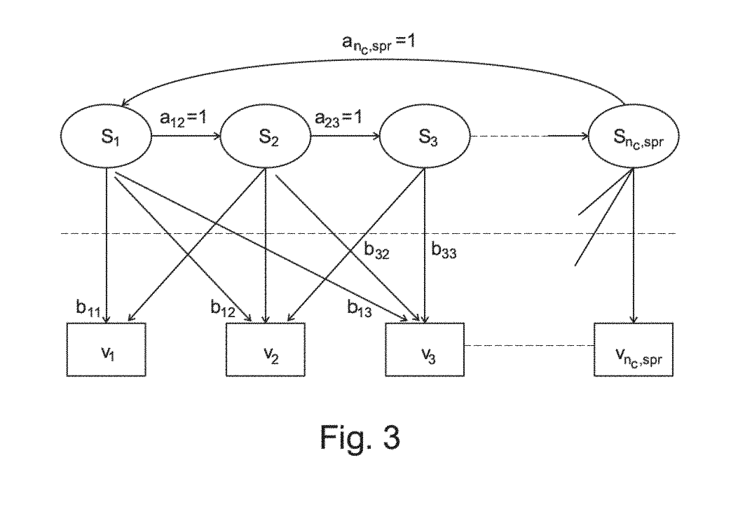

FIG. 3 shows a rendering of a Hidden Markov model;

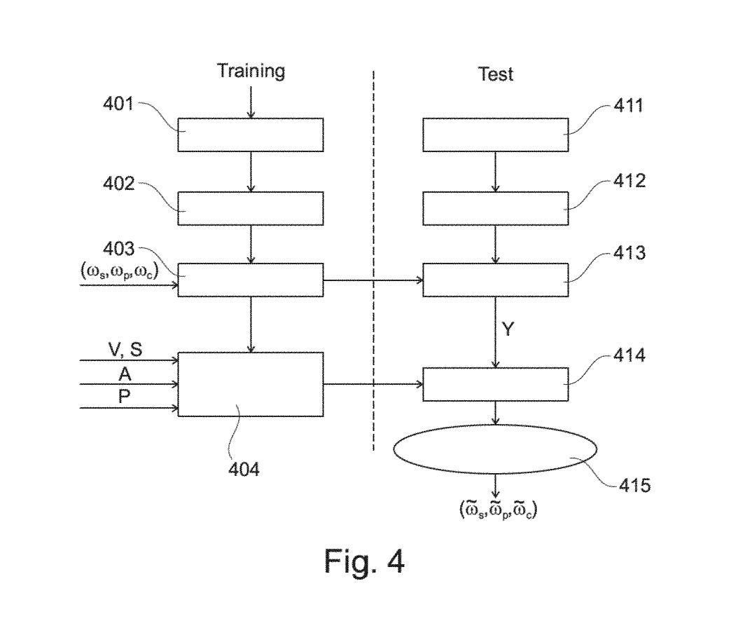

FIG. 4 shows a schematic rendering of the training of a model for pattern recognition and of the testing of pattern recognition in one embodiment of a device and in a method for monitoring the kinematics of an epicyclic planetary gearbox;

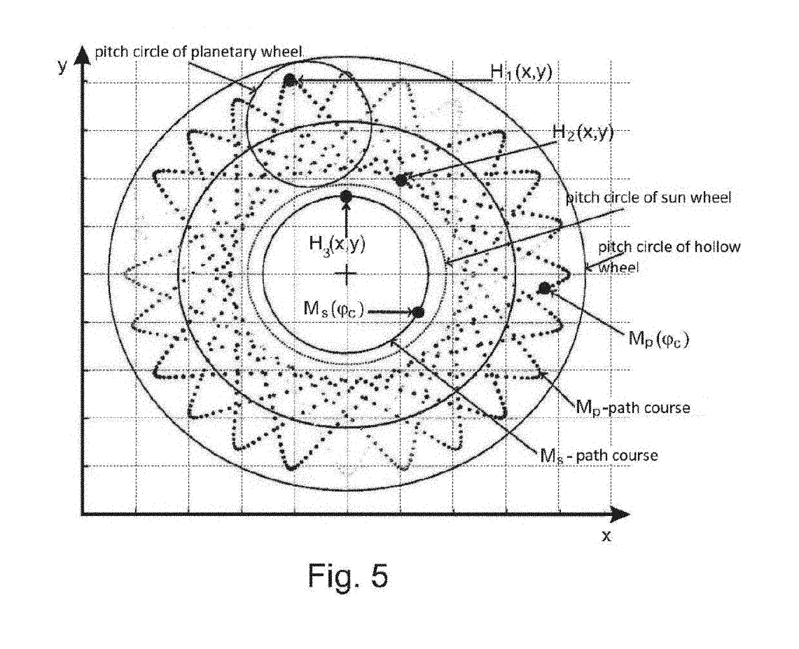

FIG. 5 shows a schematic rendering of path curves of a point on a planetary wheel;

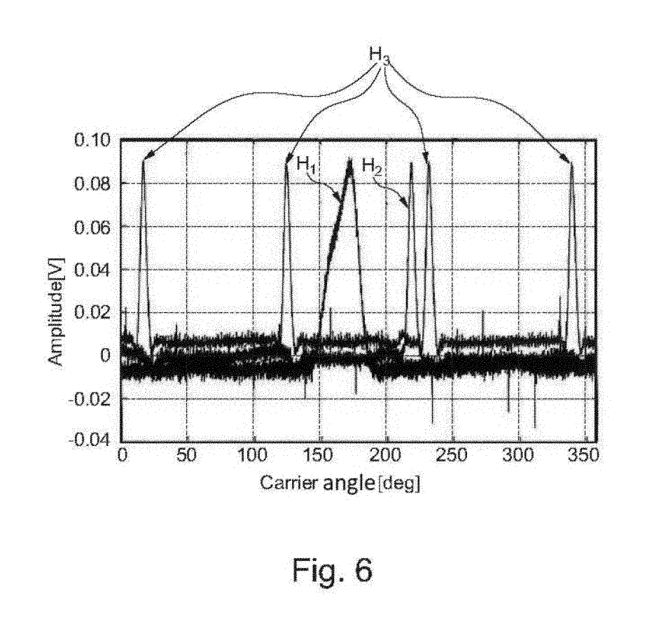

FIG. 6 shows a schematic rendering of signal curves (amplitude) across the rotational angle of a carrier (web);

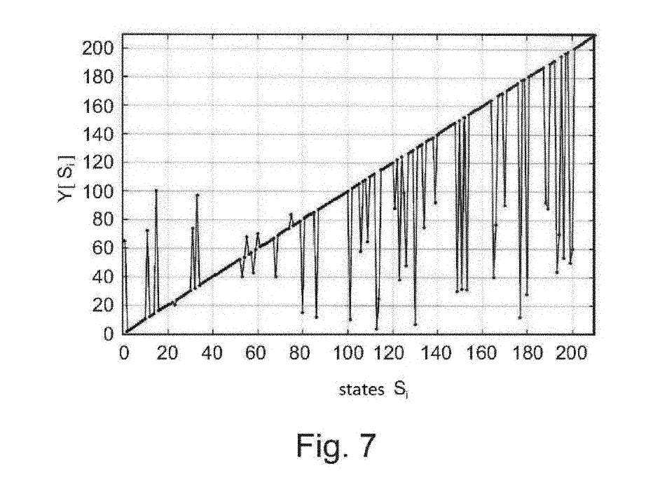

FIG. 7 shows a rendering of sequence errors in the classification;

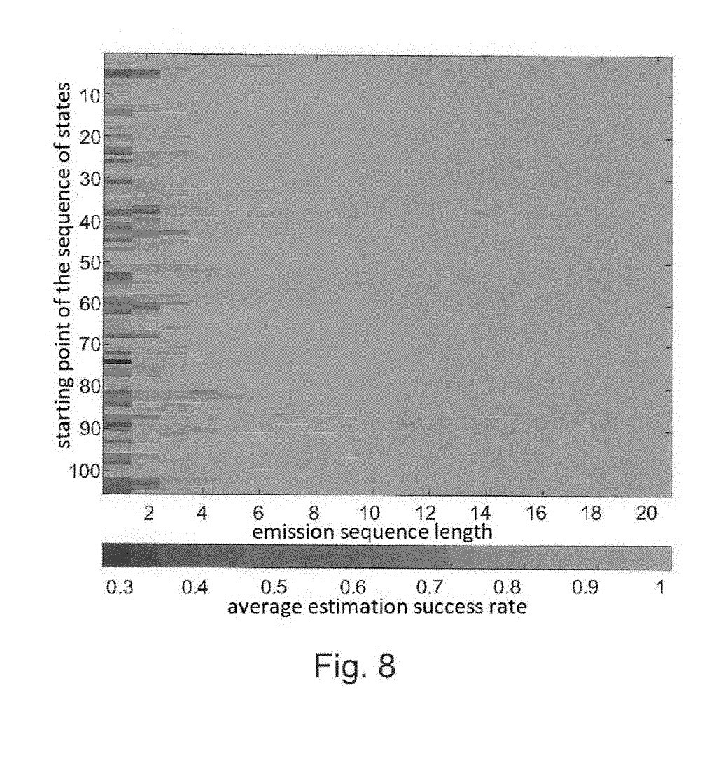

FIG. 8 shows a rendering of the estimated success rate.

Before the exemplary embodiments are discussed, the functionality and the kinematics of an epicyclic planetary gearbox 2 will be shown based on FIGS. 1A to 1D.

FIG. 1A to 1D respectively schematically show a per se known epicyclic planetary gearbox 2 with a stationary hollow wheel H (see rendering in FIG. 1A) and planetary wheels P₁, P₂, P₃. The carrier (also referred to as the planetary carrier or web) that fixedly connects the planetary wheels P₁, P₂, P₃ to each other is not shown here for reasons of clarity.

A planetary wheel P₁, P₂, P₃ of the gearbox respectively has the rotational frequency f_{P}=ω_{P}/2π. The shaft that is connected to the carrier has the output frequency f_{C}=ω_{C}/2π. The sun wheel S has the rotational frequency f_{S}=ω_{S}/2π.

The use of an epicyclic planetary gearbox 2 with three planetary wheels P₁, P₂, P₃ is chosen here merely by way of example. It is also possible to use more, in particular five, planetary wheels. Also, it is not absolutely necessary that in the stationary hollow wheel H the drive is effected via the sun wheel S and the output is effected via the carrier. In general, the drive or the output can also be respectively realized by pairing the hollow wheel H, the sun wheel S, or the carrier. In principle, it is also possible that the hollow wheel H, the sun wheel S or the carrier are respectively fixedly arranged.

A sensor device 1 serves for detecting the structure-borne noise in the epicyclic planetary gearbox 2. The structure-borne noise refers to the oscillations that propagate in the solid body of the epicyclic planetary gearbox 2, so that also the expression oscillation data is used in the following. A possible embodiment of a sensor device 1 has a piezoelectric sensor by means of which structure-borne noise can be detected.

The starting point for the embodiments that are shown in the following is the analysis of the structure-borne noises detected at or in the epicyclic planetary gearbox 2.

Many kinds of gearbox damage (e.g. bearing damage or toothing damage) to the epicyclic planetary gearbox 2 influence the structure-borne noise generation at the tooth engagement point of the toothing. Thus, gearbox damage affects the oscillation behavior of the planetary gearbox 2.

For this reason, acceleration sensors are suitable for the detection of the gear state. However, due to the planetary wheels P₁, P₂, P₃ that are rotating about the sun wheel S as well as multiple simultaneous planet tooth meshings, an acceleration sensor receives a complex amplitude-modulated vibration signal, which initially does not allow to make any conclusions regarding any possible gearbox damage.

However, as shown in the following, it is also possible to match the signatures, i.e. patterns, in the detected vibration signals resulting from the gearbox damage to the respective damage by means of certain pattern recognition processes and devices for pattern recognition.

A method for damping stochastic vibration signal portions against deterministic vibration signal portions of individual planetary wheels P₁, P₂, P₃ (i.e. the potential damage signals) is the time synchronous averaging method (TSA) which was first developed by McFadden (Technique for calculating the time domain averages of the vibration of the individual planet gears and the sun gear in an epicyclic gearbox. In: Journal of Sound and Vibration 144 (1991), No. 1, pp. 163-172).

In the following, the TSA method is explained in more detail in FIG. 2, with the kinematics of the epicyclic planetary gearbox 2 according to FIG. 1A to 1D being referred to.

Based on the assumption that all gear teeth of the planetary gearbox 2 are in the initial angular position G₀=f(ω_{S}⁽⁰⁾, ω_{C}⁽⁰⁾, ω_{P}⁽⁰⁾) at the point in time T_{C}=0, as shown in FIG. 1A. Thus, it can be exactly determined which specific gear teeth are meshing in the initial angular position G₀.

If now the drive gear wheel (which is the sun wheel S in the example of FIG. 1A to 1D) drives the planetary wheels P₁, P₂, P₃ and thus the web shaft in the rotational drive direction, the web shaft will be in its initial angular position again at T_{C}=1 (FIG. 1D).

In FIG. 1A to 1D, the first planetary wheel P₁ is highlighted by a dark color. On the first planetary wheel P₁, respectively one tooth R_{P1} is highlighted. On the sun wheel, respectively one tooth R_{S}.

However, at this angle point, the planetary wheels P₁, P₂, P₃ and the sun wheel S have a different absolute rotational angular position with respect to the initial position, as can be seen from FIG. 1D at T_{c}=1 based on the tooth markings R_{P1}, R_{S} on the planetary wheel P₁ and the sun wheel S.

According to this, the initial angular position G₀ is reached only after n_{c,spr} web shaft revolutions (see below). This number of revolutions, which is described as the “tooth meshing periodicity”, is calculated by means of the least common multiple (kgV) of the number of teeth (according to D'Elia, Mucchi, Cocconcelli, On the identification of the angular position of gears for the diagnostics of planetary gearboxes. Mechanical Systems and Signal Processing 83, (2017), pp. 305-320):

$${n}_{c , spr} = \frac{kgV ( kgV ( {z}_{P} , {z}_{H} ) , kgV ( {z}_{S} , {z}_{P} ) )}{{z}_{H}} \qquad ( 1 )$$

with
z_{H} number of teeth of hollow wheel H
z_{S} number of teeth of sun wheel S
z_{P} number of teeth of planetary wheels P₁, P₂, P₃.

In an exemplary planetary gearbox with z_{H}=120, z_{P}=35 and z_{S}=50, what results is a ncspr=35.

In the above-mentioned TSA method, the continuously recorded sensor signals (i.e. the vibration signals of the structure-borne noise) are at first post-scanned in a rotation-angle synchronous manner, and are then divided into segments, so that the segment length corresponds to the rotation period of a gear wheel to be examined.

If the method is applied to a planetary wheel P₁, P₂, P₃ with the relative rotational frequency f_{C}+f_{P}, the length of a segment corresponds to the period (f_{C}−f_{P})−1 (according to Yu, Early Fault Detection for Gear Shaft and Planetary Gear Based on Wavelet and Hidden Markov Modeling, Dissertation, University of Toronto, 2011).

Here, the signal data x in each segment are multiplied by a suitable window function w_{win},

x_{win}=xw_{win} (2)

wherein the maximum of the window function coincides with the web rotational angle point if the regarded k-th planetary gear wheel is located directly below the sensor device 1 for the vibrations. This segmentation is performed for each planetary wheel P₁, P₂, P₃; so that the segments of a planetary wheel P₁, P₂, P₃ can be matched to the respective segment set vₖ as follows.

v₁={x_{win}(T_{C}=0),x_{win}(T_{C}=1), . . . ,x_{win}(T_{C}=nₛₚᵣ)} (3)

v₂={x_{win}(T_{C}=⅓),x_{win}(T_{C}=4/3), . . . ,x_{win}(T_{C}=nₛₚᵣ+⅓)} (4)

v₃={x_{win}(T_{C}=⅔),x_{win}(T_{C}=5/3), . . . ,x_{win}(T_{C}=nₛₚᵣ+⅔)} (5)

In sufficiently large measuring data, measurement series of multiple tooth meshing periodicities are present at constant gearbox parameters (rotational speed, output torque, temperature), so that multiple windowed vibration signals are present for each x_{win} (T_{C}=n*⅓) with n ∈ [symbol] .

Proceeding from the assumption that the vibration signal patterns within the same toothing segment sets v₁ for the same T_{C} are ideally identical, the signals x_{win}*⅓) for each n=0, . . . nₛₚᵣ are subsequently averaged.

Accordingly, by means of the TSA method, the time range of the vibration oscillation signals in which a planetary wheel P₁, P₂, P₃ is close to the sensor device 1 is analyzed in isolation from the time ranges in which no planetary wheel P₁, P₂, P₃ is located close to the sensor device 1 (see Ha et al., Autocorrelation-based time synchronous averaging for condition monitoring of planetary gearboxes in wind turbines. In Mechanical Systems and Signal Processing, 70-71 (2016), pp. 161-175, and McFadden op. cit.).

In addition, stochastic vibration influences are dampened through a subsequent averaging of the determined signal data.

On the left side of FIG. 2, the amplitude signal of the vibrations is plotted over three T_{C} cycles. To the right, the vibration signals of two segment sets v₁ and v₃ for the two planetary wheels P₁, P₃ are added together across the planetary rotational angle ω₁, of the respective planet. For one thing, the windowing of the vibration signals allows for a separation of the dominating vibration portions of different toothings and thus different rotational angular positions of the planetary gearbox, and, for another thing, the leakage effect, which results in the course of a further processing of the vibration signals in the Fourier spectrum, can be reduced thanks to the windowing.

The TSA method is used for the rotation-angle synchronous averaging of vibration data. Here, if the tooth meshing periodicities are known, an averaging can be performed independently of the initial angular position G₀.

In the following, in embodiments for a method or a device, features which facilitate detection of local planet tooth damages by means of a pattern recognition system are obtained from the individual windowed signals.

However, beforehand the separation effectiveness of the obtained features has to be evaluated with respect to different severities of damage. Here, the evaluation is to be performed for different rotational speed and load ranges, so that multiple test series are carried out at an epicyclic planetary gearbox 2. However, for this purpose the windowed signal sections between different measurements must be correctly matched to the kinematic state of the epicyclic planetary gearbox 2.

This is only possible if the three rotational angles ω_{S}, ω_{P}, ω_{C} are known.

The values ω_{S} and ω_{C} can be sensorially detected at the drive shaft or the output shaft by means of an incremental encoder with zero pulse output.

However, to also determine the planetary rotational angle ω_{P}, a sensor system would have to be provided in the interior of the gear housing of the epicyclic planetary gearbox 2.

In the following, the planetary rotational angle ωp is estimated based on the rest of the sensor data (i.e. the structure-borne noise or vibration data) to be able to evaluate the feature characteristics between different measurements. If the planetary rotational angle ω_{P} is not known, it is initially also not possible to determine the initial rotational angle position G₀ of the gearbox from the measuring data.

In the embodiments that are described in the following, the initial rotational angle position G₀ of the epicyclic planetary gearbox 2 can be determined, wherein a pattern recognition is carried out. A pattern recognition 404 can e.g. use an artificial neural network (KNN), in particular a recurrent artificial neural network, a support vector machine (SVM), or also a Hidden Markov model (HMM).

In the following, a pattern recognition with a Hidden Markov model will be discussed.

States of a system can be mapped as a stochastic process by so-called Markov chains. Here, the knowledge of past states is sued for predicting future states. The order of the Markov chain determines how many past states are taken into account in the estimation of the future system state.

The Markov chain must be in one of the defined states of the set of states S={s₁, s₂, . . . , sₙ} at all times.

A Markov chain can be expanded into a stochastic model, which consist of observed as well as unobserved states. This is a Hidden Markov model, as the states of the model are not directly observed, but instead only the output V={v₁, v₂, . . . , vₙ}, produced by the states is observed.

In FIG. 3, such a Hidden Markov model is schematically shown. The transition probabilities between the states are indicated in the matrix A, and the probabilities for a certain emission vᵢ to be observed in the state sᵢ, are indicated in the matrix B (output probability matrix). Hidden Markov models have already been used for describing gearbox states (Miao et al, A probabilistic description scheme for rotating machinery health evaluation. In: Journal of Mechanical Science and Technology 24 (12) (2010), pp. 2421-2430).

However, in the known applications, the degradation process of the gearbox is described as a state to conclude the gear state based on the observed data by means of a Markov model that is acquired by training. Here, it is for example possible to differentiate between error-free, faulty or destroyed states.

But in the embodiments described herein Hidden Markov models are used for describing the kinematic gear state (in particular the angular positions of a gear wheel) of the epicyclic planetary gearbox 2 in the context of pattern recognition.

If the Hidden Markov model is applied to the above-described tooth meshing estimation (here for ω_{P}) in the epicyclic planetary gearbox 2, accordingly only the output based on the generated oscillation signal patterns is observed, and the states of the model are described by discrete rotational angular positions ω_{S}, ω_{P}, ω_{C} of the epicyclic planetary gearbox 2, with the exact rotational angles of all rotational axes remaining unknown.

In FIG. 3, a state sᵢ describes a discrete rotational angular position of the epicyclic planetary gearbox 2 with the rotational angles ω_{S}, ω_{P}, ω_{C} in the state i. This state i emits oscillation signal patterns from the output set V with the probability bᵢ. Here, the element count of the set of states and the output set are identical. Assuming that each state emits a different oscillation signal pattern vᵢ, B is a diagonal matrix in this case.

In the described approach, the transition matrix A is simplified, as shown in FIG. 3, since the tooth meshing states of the gearbox occur successively and thus all entries apart from a_{i,i+1} and aₙ_{_{c}}_{,spr,1} become zero. Accordingly, this sequence of states also emits a fixed sequence of oscillation signal patterns.

The goal now is to analyze the emission sequence and to find that path through the state graph that indicates the observed emission sequence according to the constructed Hidden Markov model. In other words, what is looked for is the sequence of toothing states that can be most likely matched to the observed oscillation signal patterns of a measurement. The initial angular position G₀ can be determined as soon as the sequence of states is known.

For uncovering the most likely sequence of states of an observed emission sequence, the Viterbi algorithm (see e.g. Forney, The Viterbi algorithm. In: Proceedings of the IEEE, 61 (1973), No. 3, pp. 268-278) can be used. Alternatively, also the Lazy Viterbi algorithm (Feldman et al., A Fast Maximum-Likelihood Decoder for Convolutional Codes; In: Proceedings of the Vehicular Technology Conference, 2002-Fall, 2002 IEEE 56th), the Forward algorithm, the Backward algorithm, a posterior decoding or a Forward-Backward algorithm such as the Baum-Welch algorithm can be used.

Here, a state transition diagram is initially generated across all points in time and all states. Subsequently, the probability for a given sequence in each node of the transition diagram of this node being reached from the previous node is calculated by means of the output probability matrix B of the Hidden Markov model.

In this manner, the most probable state path for a given sequence can be calculated, so that the concealed state can be matched by means of subsequent backward reading of the nodes of each observed emission.

To be able to successfully use the Hidden Markov model and the Viterbi algorithm for estimating the initial angular position G₀, the emitted oscillation signal patters should differ from each other as much as best possible. Thus, each meshing tooth meshing combination should have a high “uniqueness quality” in the vibration signal, so that the oscillation signal patterns can subsequently be separated from each other in a separation-effective manner.

This precondition can be regarded as qualitatively given, since gear wheels are subject to certain manufacturing variabilities, such as pitch deviations and tooth profile deviations. Thus, the embodiments described herein make use of the already present manufacturing variabilities to make vibration signals distinguishable from each other.

As a result of these variations in geometry, the contact lines on the tooth flanks of the meshed gear wheels differ from each other slightly during rolling contact. This influences the oscillation behavior of the toothing (see e.g. Heider, Schwingungsverhalten von Zahngetrieben: Beurteilung und Optimierung des Schwingungsverhaltens von Stirnrad-und Planetengetrieben, Verlag Dr. Hut, 2012; Inalpolat, Murat; Kahraman, Ahmet (2010): A dynamic model to predict modulation sidebands of a planetary gear set having manufacturing errors. In: Journal of Sound and Vibration 329 (4), 2010), so that the hypothesis can be made that the emitted oscillation signal patterns differ from each other in each subsequent tooth meshing combination.

Moreover, an analysis of the emission sequence by means of the Viterbi algorithm has the advantage that not all observed oscillation signal patterns have to necessarily differ from each other, but that it is sufficient if a portion of the generated emission sequence within a tooth meshing periodicity can be differentiated from other emission sequence portions. If that is the case, an identification of the original sequence of states can be successfully carried out.

The embodiments for monitoring the kinematics of an epicyclic planetary gearbox 2 use an estimate of the initial angular position G₀ in connection with a pattern recognition.

FIG. 4 shows processing steps of the pattern recognition system by way of example. It is divided into the partial work steps “training” (in FIG. 4 links) and “test” (on the right of FIG. 4).

Here, the training phase serves for generating a model (i.e. a calculation model) of the kinematics of the epicyclic planetary gearbox 2, as generally known in machine learning.

In an optional pre-processing step 401, the data detected by the vibration sensor device 1 can be filtered with a bandpass filter, for example. In this way, it is for example possible to filter out resonance oscillations to improve the separation effectiveness for the features in the subsequent steps.

Additionally or alternatively, also a noise reduction can be carried out. It is also possible e.g. to perform a smoothing of the measured data.

In that case, suitable feature characteristics (e.g. and among others: mean value, standard deviation, kurtosis of the pre-processed raw data) are at first obtained in the training phase (step 402) from the windowed oscillation measurement data (see FIG. 2 and the associated description), which is also referred to as feature extraction. For this purpose, one-dimensional features indicating characteristic features in determined toothing states are calculated based on one-dimensional or multi-dimensional signal representations in the rotational angle area or time-frequency area.

In general, it is possible that all determined features are included in the subsequent training of the classifier (step 403) with the same adicity. However, it is also possible to perform weighing of the features according to a defined quality functional (e.g. the F ratio). If the determined features show a rotational speed frequency dependence, this information could be taken into account as the features are obtained.

In the training phase (step 403), the classifier (e.g. a SVM or a KNN) is fed with the rotational angle dates ω_{S}, ω_{P}, ω_{C} and the feature characteristics of the individual vibration signal windows, so that the class assignment of the patterns can be trained in the feature space in a monitored training. Here, the rotational angle data ω_{S}, ω_{P}, ω_{C} facilitate exact matching of an observed oscillation signal pattern with a class of states. Weighing can also be performed during classification (step 403). In this manner it is e.g. possible for window signals, which have been detected with a greater uncertainty than others (e.g. because they are located closer to a cluster boundary), to be used with a correspondingly lower weighing. For this purpose, a vector describing the certainty of each observation would be created in the test phase in addition to the vector with the observation. This additional information could then also be included in the Viterbi algorithm (step 414, see below) at a suitable point.

If sufficiently long sequences are present, there is the possibility of searching for a section at which the classification has worked particularly well with a high probability by using the Viterbi algorithm (step 414). Such a section would e.g. stand out by the occurrence of many consecutive individual observations.

However, at the end of the training process, it can not be excluded that certain states emit patterns that are indistinguishable from each other. This leads to different states sᵢ emitting the same observations vᵢ and thus entries outside of the diagonal of the output probability matrix B become non-zero.

Thus, states having a low “uniqueness quality” at a determined tooth meshing can be described with the output probability matrix B. To determine the output probability matrix B, the misclassified observations are analyzed in the training data. As soon as the matrix B is known, the Hidden Markov model can be constructed (step 404). At that, also the observation space V (vᵢ in FIG. 3), the state space S (sᵢ in FIG. 3), the transition probability matrix A (aᵢⱼ in FIG. 3) and possibly also initial probabilities P are included in the Hidden Markov model.

At this point (step 404), the pattern recognition system is considered as acquired by training; i.e. what is present is a trained model in the form of a computer model (classifier 403, Hidden Markov model 404) that can be used for detecting gearbox damage within the frameworks of tests (steps 413, 414). As for timing, the use of the model in the test phase occurs after the training phase of the computer model and then can be used any number of times.

Next, test data (right side in FIG. 4), i.e. kinematic data of the epicyclic planetary gearbox 2, not containing any rotational angle data are processed in the test phase. Based on them, the system can independently calculate the sequence of states.

For this purpose, the first two processing steps with the pre-processing (step 411) and obtaining of features (step 412) are analogous to the training process (left side of FIG. 4).

Here, the classifier (step 413) matches each vibration signal window to an element of the observation set V, so that what results is an emission sequence for an entire measurement.

Subsequently (step 414), the Viterbi algorithm is applied to the emission sequence, and the most probable original sequence of states is uncovered. If the sequence of states is known, the initial angular position G₀ of the planetary gearbox 2 can subsequently be calculated.

As has already been mentioned, for the training process according to FIG. 4 it is necessary to provide the classifier with the rotational angle sizes ω_{S}, ω_{P}, ω_{C} in addition to the windowed signals (step 403).

However, to detect the accurate rotational angular position of all three rotational angle sizes ω_{S}, ω_{P}, ω_{C} in the training, the measurement method described below was used.

The idea of the measurement method is based on the magnetic detection of the planet trajectory path and the zero-angle position of the sun wheel S. For this purpose, in the practical realization, a permanent magnet with a low net weight and high magnetic remanence is arranged, for one thing, at the planetary wheel P₁, P₂, P₃ in the point M_{P}, so that this fixed point has a star-shaped path trajectory during the rotation of the planetary wheel P₁, P₂, P₃. For another thing, a permanent magnet is arranged at the sun wheel S in the point M_{S} so as to detect the sun wheel zero angle position.

At that, the point M_{P} reaches its starting position after

$${n}_{c , pr} = \frac{kgV ( {z}_{P} , {z}_{H} )}{{z}_{H}} \qquad ( 6 )$$

web rotations. This starting point of the magnet or the rotational angle zero point of the planetary wheel P₁, P₂, P₃ is magnetically scanned. FIG. 5 shows the Mp path trajectory (planet path) for n_{c,pr}=7 web rotations, with the respective path section being shown in a different shade of grey for each web rotation. The individual points [on] the Mp path trajectory are sampled at equidistant time intervals. But since the velocity of the points is not constant during this movement, different point distances result.

Due to the overlapping of the Mp path trajectory within n_{c,pr} web rotations, for a reliable detection the star-shaped path is scanned at two fixed points, which in FIG. 5 is indicated by H₁ (x, y) and H₂ (x, y) (positions of the scanning Hall sensor). Commercially available linear Hall sensors are used for detecting the magnetic flux density generated by the permanent magnet.

The sampling point H₁ serves for the reliable identification of the Mₚ path section, which is reached by the permanent magnet as it passes its starting position. However, since the sampling point H₁ is passed with a lower velocity, the magnetic flux density in this point has a wide peak in the time range signal (see FIG. 6).

A maximum of the magnetic flux density cannot be exactly indicated, so that a maximum value and thus also the exact point in time at which the magnet Mₚ passes the sensor H₁ is characterized by a higher uncertainty.

For this reason, the sampling point H₂ has been additionally introduced, which is passed by the planet point Mp with a higher velocity than H₁. For this reason, the magnetic flux density in this point has a narrower peak in the time range signal, and the maximum can be determined with a lower level of uncertainty. If now the marked planet point passes these two sampling points H₁ and H₂, the M_{P} path can detect all n_{c,pr} web rotations in a reliable manner.

The sensors H₁ and H₂ realize a detection of the point in time when identical tooth meshings between planetary wheel teeth and hollow wheel teeth are present. However, in order to determine the initial tooth meshing position G₀ of the planetary gearbox 2, the tooth meshings of the planetary wheels P₁, P₂, P₃ with the sun wheel S also have to be considered, as summed up in equation (1). This is achieved by scanning the sun gear rotational angular position with a further permanent magnet M_{S} and a linear Hall sensor at the location H₃ (x, y) (see also FIG. 5).

In FIG. 5, the position of the permanent magnet Mₛ is indicated as a function of the rotational angle of the carrier C.

FIG. 6 shows the time signal profiles of the three Hall sensors H₁, H₂, H₃ as they pass the two magnets Mₚ and M_{S}. Here, it has been shown that, due to the narrower peak, the sensor H₂ is better suited for determining the point in time of initial tooth meshing G₀ than sensor H₁.

Although a windowing of machine vibrations is possible according to the state of the prior art, so far the windowed vibration signals could not be matched to individual tooth engagement points across all measuring sequences without using an additional sensor system.

With the shown embodiments, this matching is now possible, and toothing-selective monitoring of the gear state of the kinematics can be realized. For this purpose, a conclusive trend analysis of individual toothings is possible for being able to detect locally occurring tooth damage or other deviations in the vibration signal at an early stage.

To test the implemented algorithms, some tests with a variable rotational speed and variable output torque have been carried out at an epicyclic planetary gearbox 2. Here, it could be shown that an estimate of the initial angular position G₀ is possible with the described approach.

The results are briefly explained in the following.

FIG. 7 shows the matching of the observed emission sequence across two “tooth meshing periodicities” with the individual toothing states by a previously trained classifier. Here, in total 210 states s₁ inside the two “tooth meshing periodicities” have been defined with 2 n_{c,spr}=70 web rotations and a total number of three planetary wheels P₁, P₂, P₃. Thus, that point in time at which one of the planetary wheels P₁, P₂, P₃ is located below an acceleration sensor device 1 attached at the hollow wheel H is always described by a discrete state.

The rendering in FIG. 7 shows the states that are matched by the classifier mapped against the real states s₁. In the case that all observed states Y (sᵢ) are matched correctly (see FIG. 3, output of the classifier in step 413), a straight line with a slope of one would result in the chosen type of rendering in FIG. 7.

Corresponding outliers of the graph are to be considered misclassifications. Here, it has been shown that a significant share of misclassifications occurs through the classifier. But there are also sequence sections with a sequence of correctly matched states. The known and recurring sequence of the occurring kinematic states is made use of in a targeted manner through the combined application of the Viterbi algorithm and the trained Hidden Markov model, as will be described in the following.

FIG. 8 shows the average success rate of all measurement series at a variable rotational speed and load with respect to the estimated initial angular position G₀. This represents the output of step 415 in FIG. 4.

Here, the same rotational speed/load combinations have respectively been used throughout for the training and the test phase.

The medium success rate is mapped in FIG. 8 as a parameter depending on the starting point sᵢ of the sequence of states (“initial state”) (y-axis) and the emission sequence length (“length of observed state sequence”) (x-axis).

Here, it has been shown that a 100 percent success rate for the correct estimate of the initial angular position G₀ could be reached in the test data in a regarded sequence length of 20 emitted states. In addition, it can be seen in FIG. 8 that, with the emission sequence length of 20, the success rate is additionally independent of the regarded starting point of the sequence of states.

Despite a significant share of misclassifications, a high success rate can be reached with the analysis when it comes to matching the initial angular position G₀ by means of the introduced method. The developed pattern recognition system shows a certain measure of robustness against misclassifications.

### PARTS LIST

1 sensor device
2 epicyclic planetary gearbox
P₁ first planetary wheel
P₂ second planetary wheel
P₃ third planetary wheel
C carrier (planetary carrier)
H hollow wheel
S sun wheel

1. A method for monitoring the kinematics of an epicyclic planetary gearbox under test, wherein
a) in a training phase, a model of the kinematics is determined by pattern recognition based on data measured at an epicyclic planetary gearbox by means of a vibration sensor device; wherein subsequently
b) the model is used in a test phase for pattern recognition in oscillation data of an epicyclic planetary gearbox to be tested, wherein angular positions of at least one planetary wheel in the epicyclic planetary gearbox to be tested are determined by means of the pattern recognition.

2. The method according to claim 1, wherein an estimate of an initial angular position of the planetary wheels is determined in the test phase by means of the pattern recognition.

3. The method according to claim 1, wherein the model that is determined based on the pattern recognition has a Hidden Markov model structure and/or an artificial neuronal net structure.

4. The method according to claim 1, wherein the training phase extends at least over at least a time period that is necessary for tooth meshing periodicity (n_{c,spr}), in particular over a time period for an integral multiple of the tooth meshing periodicity (n_{c,spr}).

5. The method according to claim 1, wherein the training phase has a preprocessing step in which a filtering of the oscillation data, a noise reduction of the oscillation data, and/or a rotation-angle synchronous post-scanning, in particular with the TSA algorithm, are performed, and/or a feature detection step.

6. The method according to claim 1, wherein the training phase performs a classification step with the classifier, which in particular chronologically followings the preprocessing step, wherein the result of the classification comprises an output probability matrix for the Hidden Markov model with parameters for the model.

7. The method according to claim 6, wherein the classifier comprises a k-nearest-neighbor algorithm, a support vector machine and/or an artificial neural network, in particular a recurrent artificial neural network.

8. The method according to claim 1, wherein a Viterbi algorithm is used in the test phase for determining a most likely sequence of angular states, in particular for determining a toothing state that is most likely to correspond to the observed oscillation signal patterns in the acquired oscillation data.

9. A device for monitoring the kinematics of an epicyclic planetary gearbox to be tested, characterized by having
a model for the kinematics of an epicyclic planetary gearbox obtained through a means for training the model based on data measured at epicyclic planetary gearboxes with a vibration sensor device, and
a means for pattern recognition in oscillation data of an epicyclic planetary gearbox to be tested, wherein angular positions of at least one gear wheel in the epicyclic planetary gearbox to be tested can be determined by means of the pattern recognition.

10. The device according to claim 9, characterized by having a means for estimating an initial angular position of the planetary wheels and/or of the sun wheel in the pattern recognition.

11. The device according to claim 9, wherein the model comprises a Hidden Markov model and/or an artificial neural network.

12. The device according to claim 9, characterized by having a means for preparing and/or means for detecting a feature by means of which filtering the oscillation data, noise reduction in the oscillation data, mathematical elimination of rotational speed variations and/or rotation-angle synchronous post-scanning with the TSA algorithm can be performed.

13. The device according to claim 9, characterized by having a classifier for determining an output probability matrix (B).

14. The device according to claim 13, wherein the classifier comprises a support vector machine and/or an artificial neural network.

15. The device according to claim 9, wherein a Viterbi algorithm can be used in the test phase for determining a most likely sequence of states, in particular for determining a toothing state, which is most likely to correspond to the observed oscillation signal patterns in the acquired oscillation data.
